(19) United States
(12) Patent Application Publication
(10) Pub. No.: US 2003/0027518 A1
(43) Pub. Date: Feb. 6, 2003

(54) Remote control transceiver and data communication system using the same

(76) Inventors: Akio Miyajima, Osaka (JP); Yukihiro Ishihara, Osaka (JP); Yoshiharu Abe, Osaka (JP)

Correspondence Address: RATNERPRESTIA, P O BOX 980, VALLEY FORGE, PA, 19482-0980, US

(21) Appl. No.: 10/150,721

(22) Filed: May 16, 2002

(30) Foreign Application Priority Data
May 18, 2001 (JP) 2001-149086

(51) Int. Cl. H04H 1/00; H04B 1/38; H04M 1/00

(52) U.S. Cl. 455/3.01; 455/556; 455/73

(57) ABSTRACT

A simply structured remote control transceiver that stores various data supplied is disclosed. A data communication system employing the same transceiver is also disclosed. The remote control transceiver includes a signal transceiver, a controller, an operating section, a memory and a display. The signal transceiver transmits/receives radio wave or an infrared signal to/from a television receiving apparatus (TVRA). The controller is coupled with a signal transceiver, an operating section, a memory and a display. The memory stores data sent from the TVRA via the signal transceiver. Responsive to an operation through the operating section, the display displays data read out from the memory. The data communication system includes this remote control transceiver, the TVRA and a base station that handles data.

### FIELD OF THE INVENTION

The present invention relates to a remote control transceiver that remote-controls various electronic devices such as a television receiving apparatus, and it also relates to a data communication system using the same transceiver.

### BACKGROUND OF THE INVENTION

Various types of information communication services are available now. A home-use television receiving apparatus (hereinafter referred to as TVRA) having the following functions is introduced in the market: not only receiving broadcast waves including audio and video signals from broadcasting stations, but also receiving various information from base stations such as the internet via information communication networks. Such a TVRA usually comes with a remote control transmitter for operating the functions discussed above.

Such a conventional remote control transmitter and a data communication system using the transmitter are described hereinafter with reference to FIG. 9 and FIG. 10. FIG. 9 is a block diagram illustrating the conventional remote control transmitter and the data communication system using the transmitter. In FIG. 9, TVRA 102 is coupled with broadcasting station 103 and base station 104 via cables or radio. TVRA 102 is operated with remote control transmitter 101.

Remote control transmitter 101 comprises operating section 105, display 106, memory 107, signal transmitter 108 and controller 109. Operating section 105 includes a plurality of operating keys. Display 106 such as an LCD displays what is done through operating section 105. Memory 107 stores remote control signals sent to TVRA 102. Signal transmitter 108 sends remote control signals transmitted by infrared ray to TVRA 102. Controller 109 reads out the remote control signals stored in memory 107 responsive to an operation of operating section 105. Controller 109 controls the respective elements discussed above.

In the structure described above, when an operating key of operating section 105, e.g., a channel key or a volume key, is pressed, controller 109 reads out, based on this operation, a remote control signal stored in advance in memory 107 so as to execute this operation, and outputs it to signal transmitter 108.

The remote control signal is transmitted by infrared ray from signal transmitter 108, thereby operating TVRA 102. For instance, broad casting station 103 currently received is changed to another channel, or the sound volume is increased or decreased.

In the case that TVRA 102 has a function of communicating with base station 104 of an information communication network, a depress of an input change-over key of operating section 105 prompts signal transmitter 108 to send an input change-over signal to TVRA 102. When TVRA 102 receives this signal, screen 102A displays a video based on data, which is supposed to be received by TVRA 102 via the information communication network from base station 104.

Further operation through the cursor key and other keys of operating section 105 is done for selecting a desirable menu, e.g., weather forecast 102B, then an enter key is pressed for confirmation. TVRA 102 then requests the base station to send the data of the menu selected. Base station 104 sends the requested data to TVRA 102, so that videos based on the information are displayed on the screen.

As discussed above, when TVRA 102 has a function of communicating with base station 104 of an information communication network, one system for data communication is formed.

In this example, TVRA 102 receives not only broadcast waves including audio and video signals from broadcasting station 103, but also various information from base station 104 responsive to operations of remote control transmitter 101. The information from base station 104 is displayed on the screen of TVRA 102. Remote control transmitter 101 is thus included in such a data communication system.

### SUMMARY OF THE INVENTION

The present invention aims to provide a simply structured remote control transceiver that can store various data supplied to a television receiving apparatus. It also aims to provide a data communication system using the same transceiver. The transceiver of the present invention comprises a signal transceiver, a controller, an operating section, a memory and a display.

The signal transceiver is for transmitting/receiving radio wave or an infrared signal to/from a television receiving apparatus.

The controller is coupled with the signal transceiver, the operating section and the memory and the display.

The memory stores data from the television receiving apparatus via the signal transceiver.

The display displays data read out from the memory responsive to an operation through the operating section.

The data communication system of the present invention includes the remote control transceiver, the television receiving apparatus, and a base station that handles data. The television receiving apparatus receives data from the base station responsive to operation through the operating section, and the remote control transceiver receives the data from the television receiving apparatus for storing.

### BRIEF DESCRIPTION OF THE DRAWINGS

FIG. 1 is a block diagram of a remote control transceiver and a data communication system in accordance with a first exemplary embodiment of the present invention.

FIG. 2 shows an appearance of the remote control transceiver in accordance with the first embodiment.

FIGS. 3A and 3B show screens where videos output from a television receiving apparatus in accordance with the first embodiment are displayed.

FIGS. 4A and 4B show block diagrams illustrating a remote control transceiver and a data communication system using the same transceiver in accordance with a second exemplary embodiment.

FIG. 5 shows an appearance of the remote control transceiver in accordance with the second embodiment.

FIGS. 6A, 6B and 6C show screens where videos output from a television receiving apparatus in accordance with the second embodiment are displayed.

FIG. 7 is a block diagram illustrating a remote control transceiver and a data communication system using the same transceiver in accordance with a third exemplary embodiment.

FIG. 8A, 8B and 8C show screens where videos output from a television receiving apparatus in accordance with the third embodiment are displayed.

FIG. 9 is a block diagram illustrating a conventional remote control transmitter and a data communication system using the same transmitter.

FIG. 10 shows a screen where a video output from a television receiving apparatus of a data communication system using the conventional control transmitter.

### DETAILED DESCRIPTION OF PREFERRED EMBODIMENTS

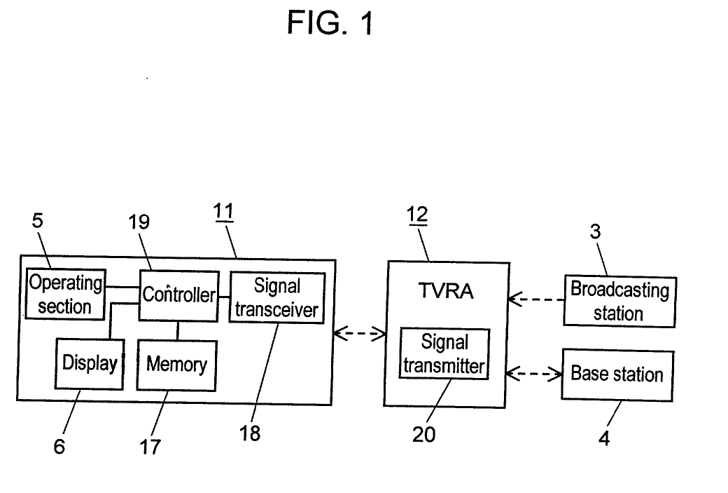

Exemplary embodiments of the present invention are demonstrated hereinafter with reference to FIG. 1 through FIG. 8. In the descriptions below, the “television receiving apparatus” refers to various apparatus which have a function of receiving a television broadcast. Thus the television receiving apparatus includes a television receiver incorporating with a display. Further, the television receiving apparatus includes, e.g., a set-top-box (STB), a television tuner & receiver, a satellite broadcast receiving tuner, which are independent of a display. The television receiving apparatus still includes a video player (VCR) and a DVD player both of which can receive television broadcast. The television receiving apparatus still further includes apparatuses, such as a personal computer, of which main function is other than receiving television broadcast, but it has also a function of receiving television broadcast.

In the descriptions below, the television receiving apparatus can receive not only broadcast signals such as terrestrial broadcasts, satellite broadcasts, and cable television broadcasts, but also information from e.g., the internet via a base station of an information communication network. The television receiving apparatus is referred to as TVRA, and a television is referred to as TV in the following exemplary embodiments.

### Exemplary Embodiment 1

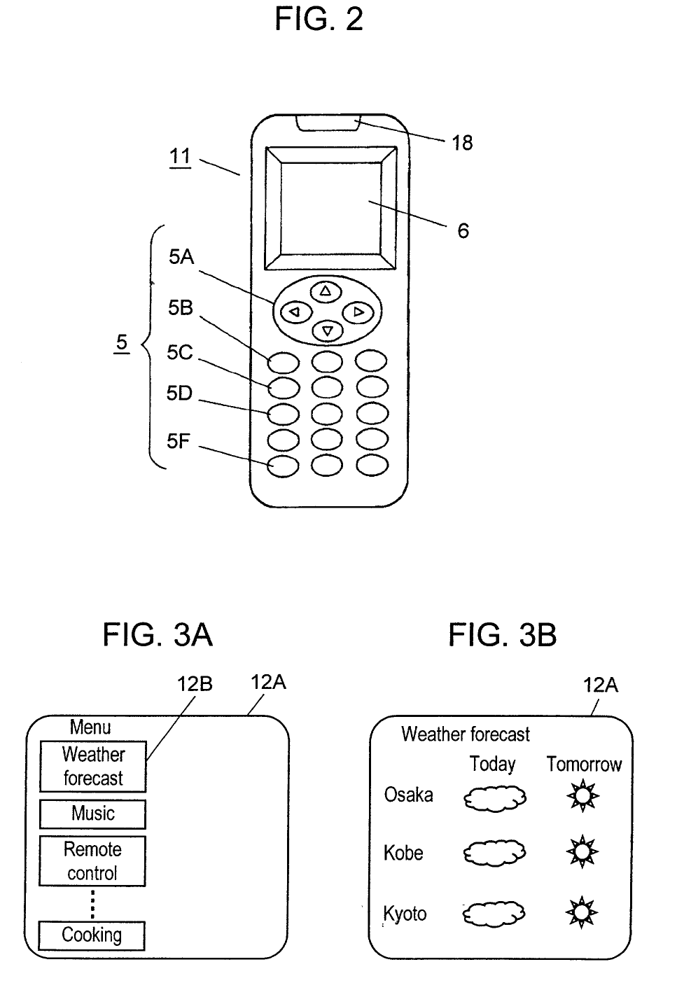

FIG. 1 is a block diagram of a remote control transceiver and a data communication system in accordance with the first exemplary embodiment. FIG. 2 shows an appearance of the remote control transceiver in accordance with the first embodiment. In FIG. 1, TVRA 12 is coupled with broadcasting station 3 and base station 4 via cables or radio. Remote control transceiver 11 includes signal transceiver 18 that transmits/receives data to/from TVRA 12. TVRA 12 includes signal transmitter 20 which transmits data to remote control transceiver 11.

Remote control transceiver 11 includes operating section 5 in which a plurality of operating keys are arranged. Display 6 using such as an LCD displays what is done through operating section 5. Memory 17 stores remote control signals applicable to TVRA 12 as well as various data sent from TVRA 12. Signal transceiver 18 transmits/receives radio wave or infrared signals to/from TVRA 12. Controller 19 reads out the remote control signal or the data stored in memory 17 upon request through operating section 5.

In the structure discussed above, when a key, e.g., a channel key or a volume key, of operating section 5 on transceiver 11 is pressed, controller 19 reads out, based on this operation, a remote control signal stored in advance in memory 17 to execute this operation, and outputs it to signal transmitter 18, which then transmits the remote control signal to TVRA 12. Remote control transceiver 11 thus controls TVRA 12, for instance, channel 3 presently received is switched to another channel, or a sound volume is increased or decreased.

When input change-over key 5F of operating section 5, for instance, is pressed, TVRA 12 receives a signal that is sent based on this operation. At this time, TVRA 12 is changed over from a status of receiving broadcast signals to a status of receiving information from base station 4 in an information communication network.

When TVRA 12 is set at the status of receiving the information from base station 4, screen 12A that displays an output video of TVRA 12 displays the video shown in FIG. 3A. Further operation through cursor key 5A and other keys of operating section 5 is done for selecting a desirable menu, e.g., weather forecast 12B, then an enter key is pressed for confirmation. Then the data of the selected menu, i.e., weather forecast, is sent. The video of weather forecast as shown in FIG. 3B is thus displayed.

After this, according to the present invention, a predetermined operation prompts memory 17 to store various data. A further operation of operating section 5 makes controller 19 read out the data stored in memory 17 and outputs it to signal transceiver 18 or display 6.

For instance, when TVRA 12 displays the screen shown in FIG. 3B, memory key 5C is pressed, which prompts signal transmitter 20 of TVRA 12 to transmit the data of screen 12A that shows an output video of TVRA 12 to remote control transceiver 11. Signal transceiver 18 of remote control transceiver 11 receives the data, and controller 19 stores the data in memory 17.

Next, assume that call key 5D is pressed, then controller 19 reads out the data stored in memory 17 to outputs it to display 6. Controller 19 prompts display 6 to display data of screen 12A, the same as shown in FIG. 3B. Screen 12A is to show an output video of TVRA 12.

As such, remote control transceiver 11 of the present invention can retrieve various data stored anytime and at any place.

According to this first embodiment, signal transceiver 18 receives various data, which has been supplied to TVRA 12 from base station 4, from TVRA 12. Memory 17 stores the data. Responsive to an operation through operating section 5, controller 19 reads out the data and prompts transceiver 18 or display 6 to output the data.

Remote control transceiver 11 is thus structured. Therefore, a simply structured remote control transceiver that can store various data supplied to a TVRA is obtainable.

### Exemplary Embodiment 2

The second embodiment is demonstrated hereinafter. Elements similar to those in the first embodiment have the same reference marks, and the descriptions thereof are omitted here.

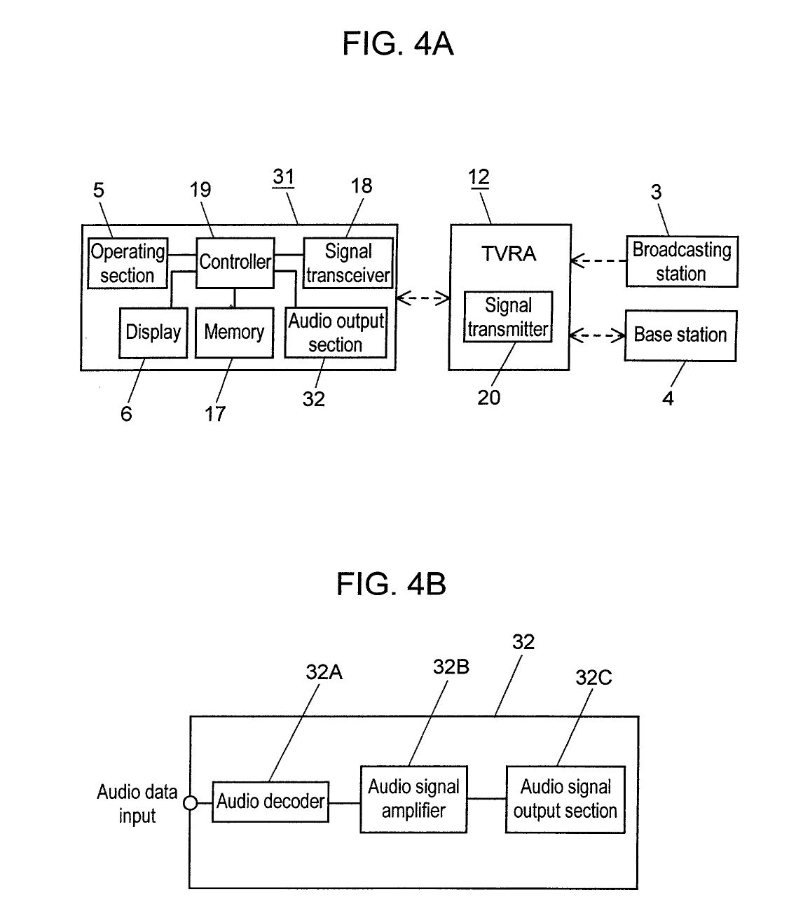

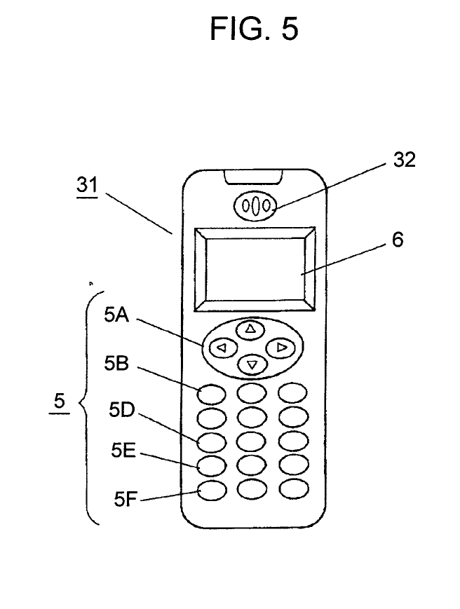

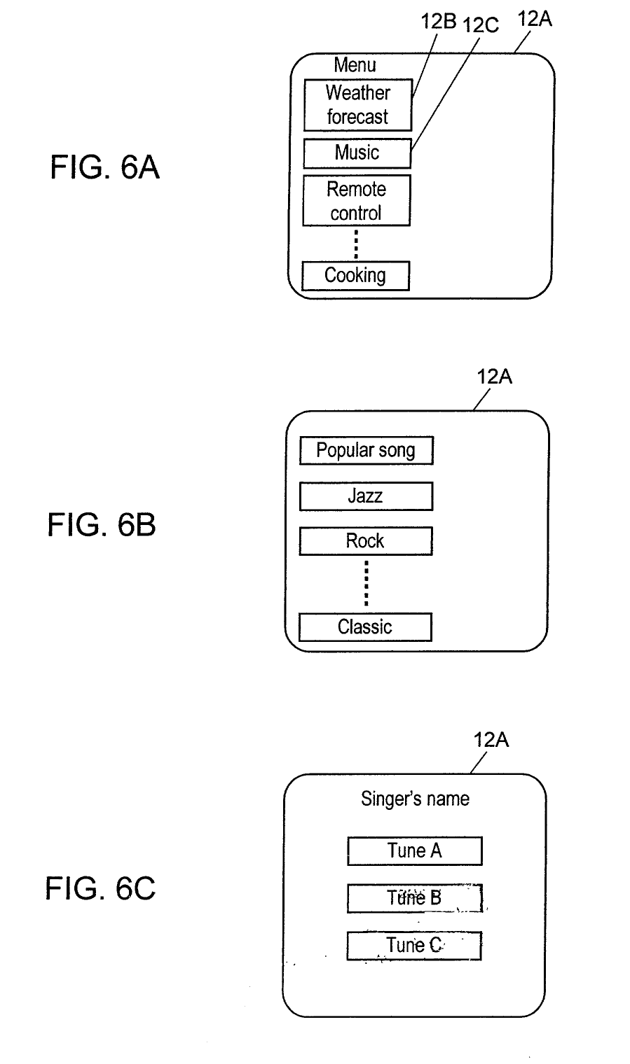

FIG. 4 shows block diagrams illustrating a remote control transceiver and a data communication system using the same transceiver in accordance with the second exemplary embodiment. FIG. 5 shows an appearance of the remote control transceiver in accordance with the second embodiment. FIGS. 6A, 6B and 6C show screens where videos output from a TVRA in accordance with the second embodiment are displayed.

In FIG. 4, remote control transceiver 31 includes operating section 5, display 6, memory 17, signal transceiver 18 and controller 19. This is the same manner as the first embodiment. Remote control transceiver 31 further includes audio output section 32.

Hereinafter described is a method of transmitting/receiving data with remote control transceiver 31 to/from base station 4 in an information communication network. First, input change-over key 5F is pressed, then a video shown in FIG. 6A is displayed on screen 12A that displays an output video of TVRA 12.

Next, cursor key 5A of operating section 5 is operated for selecting a desirable menu, e.g., music 12C. Then enter key 5B is pressed for confirmation, and data is transmitted from base station 4 to TVRA 12. At this time, music-related data as shown in FIG. 6B is displayed.

In the same manner, selection and confirmation are repeated from here onward, so that a video as shown in FIG. 6C is displayed on screen 12A that displays an output video of TVRA 12. Next, cursor key 5A of operating section 5 is operated for selecting a desirable tune, e.g., tune A, and then enter key 5B is pressed for confirmation. At this time, TVRA 12 requests base station 4 to transmit the data about tune A. Then the data about tune A is transmitted from base station 4 to remote control transceiver 12 via signal transmitter 20 of TVRA 12. Transceiver 31 receives the data, and controller 19 stores the data in memory 17.

From here onward, selection and confirmation are repeated in the same manner, and data about a plurality of tunes B, C and the like are stored in memory 17.

When call key 5D is pressed, controller 19 reads out the data stored in memory 17, and displays the data on display 6, so that names of tunes stored in the memory are displayed on display 6 similar to what is shown in FIG. 6C.

Further, cursor key 5A of operating section 5 is operated for selecting a desirable tune, e.g., tune A among one or plural tunes displayed. Then enter key 5B is pressed, which prompts controller 19 to read out the data about tune A from memory 17. The data is output as sound from audio output section 18.

Audio output section 32 includes audio decoder 32A, audio signal amplifier 32B, and audio signal output section 32C. Audio decoder 32B decodes the data coded by an audio coding method employed in base station 4.

According to the second embodiment discussed above, remote control transceiver 31 includes audio output section 32. Controller 19 reads out data from memory 17, and supplies it to audio output section 32 for outputting it as sound. This mechanism proves that when data supplied from base station 4 to TVRA 12 includes sound, the sound can be recorded and reproduced.

Data supplied from TVRA 12 can be converted to remote controlling signals. In other words, a remote controlling signal that operates a given electronic device from a remote place can be stored in memory 17.

Hereinafter described is a case where a remote controlling signal that operates a given electronic device from a remote place is stored in memory 17. When a video shown in FIG. 6A is displayed on the screen that displays an output video of TVRA 12, a “remote control” is selected from the menu.

Next, a given electronic device is selected from a plural names of electronic devices displayed on the screen. Then enter key 5B is pressed for confirmation. At this time, TVRA 12 requests base station 4 to transmit data of remote controlling signals assigned for operating the given electronic device from a remote place. Base station 4 transmits, via signal transmitter 20 of TVRA 12, the data of the remote controlling signals for operating the given electronic device to remote control transceiver 31. Signal transceiver 18 of remote control signal transceiver 31 receives the data, and controller 19 stores the data in memory 17. Selection and confirmation are repeated from here onward in the same manner, so that remote controlling signals for operating plural given electronic devices are stored in memory 17.

Then call key 5D is pressed for retrieving the data stored in memory 17. At this time, display 6 displays names of plural electronic devices operable by remote control. After a desirable device is selected, enter key 5B is pressed for confirmation. At this time, controller 19 reads out the data about the remote controlling signal assigned to the desirable device from memory 17, and outputs the data from signal transceiver 18. Remote control transceiver 31 can thus operates the desirable electronic device from a remote place.

Further, remote control transceiver 31 can store various data supplied to TVRA 12 from broadcasting station 3 or base station 4 in a given electronic device.

The given electronic device has a function of decoding the data supplied from TVRA 12 and storing the decoded data. For instance, cooking is selected from the menu shown in FIG. 6A, then selection and confirmation are repeated as discussed above, so that a predetermined data for a given microwave oven to cook automatically is stored in memory 17.

Then if transmission key 5E is pressed, controller 19 reads out given data stored in memory 17 and transmits the data to signal transceiver 18. Signal transceiver 18 transmits the data to the given microwave oven. As a result, if the microwave oven is able to decode and store the data which the microwave oven has received by itself, the microwave oven can store the data.

As discussed above, controller 19 outputs the data read out from memory 17 to signal transceiver 18, which transmits the data to a given electronic device. This embodiments proves that when data is a remote controlling signal for operating a given electronic device from a remote place, one remote control transceiver 31 can operate a plurality of electronic devices from a remote place. The given electronic device can receive, via remote control transceiver 31, various data supplied to TVRA 12 and store the various data.

### Exemplary Embodiment 3

The third embodiment is demonstrated hereinafter. Elements similar to those in the first and second embodiments have the same reference marks and the descriptions thereof are omitted here.

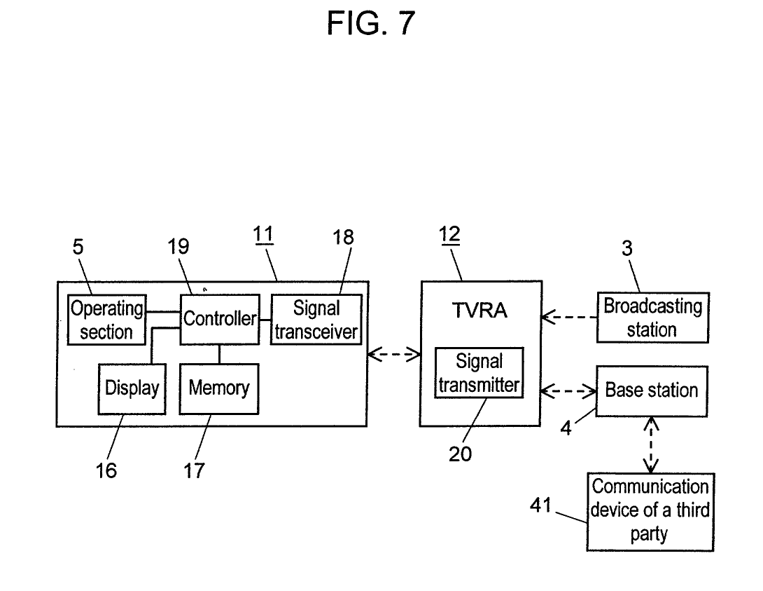

FIG. 7 is a block diagram illustrating a remote control transceiver and a data communication system using the same transceiver in accordance with the third exemplary embodiment. In FIG. 7, a TVRA 12 is coupled with broadcasting station 3 and base station 4 via cables or radio. This is the same manner as the first and second embodiments; however, in this third embodiment, base station 4 is coupled with communication device 41 of a third party.

In the structure discussed above, the third party as an individual transmits a mail using communication device 41 to remote control transceiver 11 via base station 4. The third embodiment describes an operation in this case.

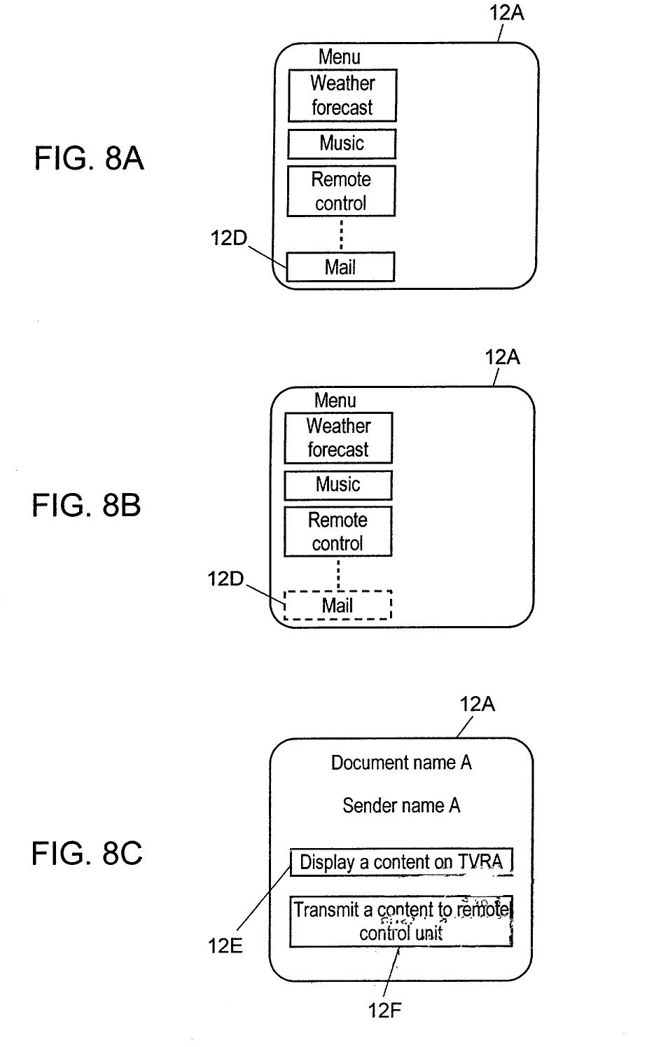

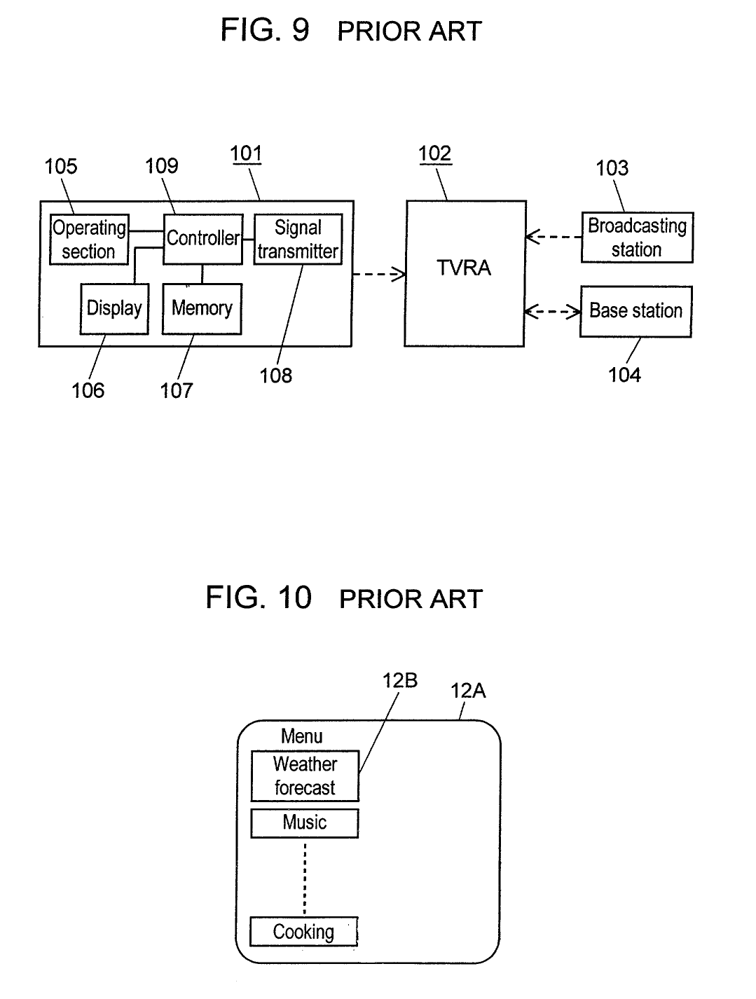

First, input change-over key 5F is pressed as the same manner as the first and second embodiments, then screen 12A that displays an output video of TVRA 12 displays the video shown in FIG. 8A. When the third party transmits a mail with communication device 41, base station 4 stores a content of the mail together with an identification No. of TVRA 12 supposed to receive the mail. Further, base station 4 transmits a signal of mail-arrival to TVRA 12, which changes display 12 showing “mail” to blinking “mail” as shown in FIG. 8B upon receiving the signal.

Next, cursor key 5A of operating section 5 is pressed for selecting “mail” blinking from the menu, then enter key 5B is pressed for confirmation. TVRA 12 sends a signal of requesting base station 4 to send the stored mail to base station 4, which then sends the content of the stored mail to TVRA 12 responsive to the request. At this time, the content is stored in a memory (not shown) of TVRA 12. As shown in FIG. 8C, TVRA 12 displays a name of the document and a name of a sender, both being parts of the mail content.

At this time, cursor key 5A of operating section 5 is depressed for selecting item 12E, i.e., “display a content on TVRA”. Then enter key 5B is pressed for confirmation, and the whole content of the mail is displayed on the S screen that displays an output video of the TVRA. If item 12F, i.e., “transmit a content to the remote control unit” is selected instead of item 12E, and enter key 5B is pressed for confirmation, then signal transmitter 20 of TVRA 12 transmits the data of the mail content, which is received by signal transceiver 18 of remote control transceiver 11. Controller 19 stores the data in memory 17.

A predetermined operation, such as pressing call-key 5D, reads out the data stored in memory 17. Display 6 then displays the content of the data, so that a user can read the content of the mail using remote control transceiver 11.

In the case that the third party is a manufacturer of an electronic device, the following applications are available: For instance, a given manufacturer of an electronic device registers the data of remote control signals of a predetermined electronic device to base station 4, and updates the data. As such, when a change or an addition is needed to the data of remote control signals stored in base station 4, necessary data can be registered to base station 4 without delay.

A system structure as follows is worth thinking. Base station 4 supplies the data of remote control signals of a given electronic device to TVRA 12, and stores as well as manages an identification No. of TVRA 12 to which base station 4 supplies the data. In such a system, when a change or an addition is needed to the data of remote control signals stored in base station 4, base station 4 can inform this fact via a mail to a user of TVRA 12, to which base station 4 supplies the data. This system thus can easily provide users with such services as changing the content of data supplied to TVRA 12.

According to the third embodiment as discussed above, the following operation is obtainable: a third party sends a given data to base station 4, and TVRA 12 receives this data. Remote control transceiver 11 stores the data via TVRA 12. Thus a data communication system, in which remote control transceiver 11 can receive and store various data including a message mail from a third party and remote controlling data, is obtainable.

In the demonstration discussed above, broadcasting station 3 is described as a station that communicates with TVRA 12 in audio & video, and base station 4 is described as a station that communicates with TVRA 12 in data of various information. When one of the stations works also as the other station at the same time, or one of the stations communicates with TVRA 12 via the other station, the present invention is still applicable.

To be more specific, a cable television broadcasting station supplies television broadcast and sends/receives information obtained from the internet via an information communication network to/from TVRAs using a bandwidth of the cable television.

According to the present information discussed above, a simply structured remote control transceiver that can store various data supplied to a television receiving apparatus is obtainable, and a data communication system using the same transceiver is also obtainable.

What is claimed is:

1. A remote control transceiver comprising:
(a) a signal transceiver for transmitting/receiving one of radio wave and an infrared signal to/from a television receiving apparatus (TVRA);
(b) a controller to be coupled with said signal transceiver;
(c) an operating section to be coupled with said controller;
(d) a memory to be coupled with said controller and for storing data which said signal transceiver receives from the TVRA; and
(e) a display to be coupled with said controller and for displaying data read out from said memory responsive to an operation through said operating section.

2. The remote control transceiver of claim 1 further comprising an audio output section for outputting the data, which said controller reads out from said memory, as sound.

3. The remote control transceiver of claim 2, wherein said audio output section comprises an audio signal decoder, an audio signal amplifier and an audio signal output section.

4. The remote control transceiver of claim 1, wherein said controller reads out the data from said memory and transmits the data to a predetermined electronic device via said signal transceiver.

5. The remote control transceiver of claim 4, wherein the data read out from said memory includes data with which the predetermined electronic device controls by itself.

6. The remote control transceiver of claim 4, wherein the data read out from said memory includes a remote control signal assigned to the predetermined electronic device.

7. A data communication system comprising:
(a) a remote control transceiver including:
(i) a signal transceiver for transmitting/receiving one of radio wave and an infrared signal to/from a television receiving apparatus (TVRA);
(ii) a controller to be coupled with said signal transceiver;
(iii) an operating section to be coupled with said controller;
(iv) a memory to be coupled with said controller and for storing data which said signal transceiver receives from the TVRA; and
(v) a display to be coupled with said controller and for displaying data read out from said memory responsive to an operation through said operating section,
(b) the TVRA; and
(c) a base station for handling data,
wherein the TVRA receives data from said base station responsive to an operation through said remote control transceiver, which receives the data from the TVRA and stores the data.

8. The data communication system of claim 7, wherein a third party sends a predetermined data to said base station, and the TVRA receives the predetermined data from said base station.

9. The data communication system of claim 8, wherein the predetermined data includes a remote control signal assigned to a predetermined electronic device.

10. The data communication system of claim 7, wherein said controller reads out data from said memory and transmits the data to a predetermined electronic device via said signal transceiver.

11. The data communication system of claim 10, wherein the data read out from said memory includes data with which the predetermined electronic device controls by itself.
